(19) United States
(12) Patent Application Publication
(10) Pub. No.: US 2011/0033653 A1
(43) Pub. Date: Feb. 10, 2011

(54) INSERT FOR A HOB

(75) Inventors: Bernd Martin, St. Georgen (DE); Markus Schlegel, Bretten (DE); Thomas Stein, Taufkirchen/Vils (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/672,720

(22) PCT Filed: Sep. 2, 2008
(86) PCT No.: PCT/EP2008/061569

§ 371 Date: Feb. 9, 2010

(30) Foreign Application Priority Data
Sep. 4, 2007 (DE) 10 2007 041 908.4

(51) Int. Cl. B32B 3/02; B32B 17/06; B32B 3/00; C03C 3/00; B32B 3/10

(52) U.S. Cl. 428/81; 428/426; 428/156; 501/11; 428/172; 428/210

(57) ABSTRACT

An insert for a hob having a material that is permeable to light in a blue spectral range.

The invention relates to a hob which is embodied from a light-permeable material.

A device for technical control of the operation of the heating elements of areas of cooker hobs is known from DE 87 01 926 U1. The cooker comprises a cooking surface with a rectangular glass ceramic plate as well as a display panel strip which is embodied separately from the glass ceramic plate and the front edge of which adjoins the glass ceramic plate. The display panel strip is embodied as transparent and light emitting diodes can be arranged below it. The glass ceramic plate and the display panel strip are surrounded by a frame, with the glass ceramic plate and the display panel strip being able to be sealed in relation to the frame and in relation to each other. The display panel strip thus extends beyond the dimensions of the glass ceramic plate. The arrangement is thus very space-intensive.

Furthermore a cooker with a hotplate is known from DE 103 12 449 A1, which has a hotplate cover plate made of glass ceramic. In addition the hotplate comprises an insert plate which is arranged within the hotplate cover plate and is therefore surrounded by the latter over its entire edge. The insert plate is preferably likewise a glass ceramic plate. It can however be specified with coloring agents, color layers, color pigments or color overlays. A gap embodied between the insert plate and the hotplate cover plate is covered by a decorative frame. This only allows a relatively inadequate attachment and positioning of the components in relation to one another and gives very restricted display options.

In addition a hob with a cooking surface made of glass or glass ceramic is known from DE 196 12 621 C2. At least one function zone which can be made of glass or glass ceramic is let into the cooking surface. This function element is mounted in a cutout of the hob flush with the latter by means of a temperature-resistant, sealed and permanently-elastic connection. The connection can be embodied as an elastic or as a rigid connection and also be a silicon rubber for example. The function zone can thus also be glued into the cooking surface. Display elements can be arranged underneath the function zone, with the function zone then serving as a display surface and preferably being embodied from a transparent, non-colored glass or plastic. By arranging the function zone within the cooking surface, this function zone occupies a relatively large amount of space and thus minimizes the possible space for other components or zones of the hob. In addition the display option for this function element or the function zone respectively is greatly restricted with respect to different colorings of the display.

Glass ceramic hobs generally have red displays since commercially-available glass ceramic only lets light in the red spectral range pass through it. Light in the yellow spectral range is corrupted to the extent that it appears to the observer as orange. All other colors are greatly weakened or even completely absorbed, this especially being the case in the blue spectral range and also for white light.

The object of the present invention is to create an insert which makes a more flexible display of information possible. This object is achieved by an insert having the features claimed in claim 1.

The inventive insert for a hob is embodied from a light-permeable material. The insert is permeable to light in the blue spectral range. Such an embodiment enables an improved and more flexible color display of indicators and the like to be achieved by comparison with an insert embodied only from glass ceramic.

In particular the insert is embodied from a material other than glass ceramic.

Preferably the insert is embodied from glass, especially gray glass. However another material, for example plastic, can also be provided, with the essential aspect being that this material is translucent to light in the blue spectral range. A display and/or control area integrated into the cooking surface can thus be improved in respect of the color display and thereby greater ease of recognition for a user. This can be achieved by the insert and the components arranged below it, especially the electronics and light sources.

Preferably the insert has a black coating on at least some areas of its rear side that is permeable to light in the blue spectral range. Such a design enables the insert to be positioned adjacent to a glass ceramic in the hob and for the overall optical impression to be given that the insert and the glass ceramic consist of one and the same material. In addition, by applying such a black coating to the rear side of the insert, the ability to see through the insert from above can be minimized and the components arranged below, especially the electronics and at least one light source, can be hidden. Hiding the light source is to be understood here as its emitted light passing through the insert in the source's activated state, but the light source as such with its design etc. not being visible or being almost undetectable, especially in the deactivated state. In addition, applying the black coating to the rear side prevents damage to it from scratches or the like.

The coating can be embodied as a film or can be printed on. Preferably at least one symbol and/or a scale is applied to the rear side of the insert. These elements can also be applied as a film or printed on.

Preferably at least one centering element is embodied on the rear side of the insert, which is embodied for relative positioning in relation to a further component of the hob, especially a display unit and/or a light source. This makes a very precise positioning between the components possible which guarantees an especially precise backlighting of specific surface areas of the insert. Unsharp backlighting and a resulting image perceived as being unsharp or an unsharp optical display can be avoided in this way.

Preferably the insert is embodied in the shape of a trapezoid. In particular the insert is designed to be used at the outside edge of a hob.

An exemplary embodiment of the invention is explained below in greater detail with reference to schematic drawings. The figures show:

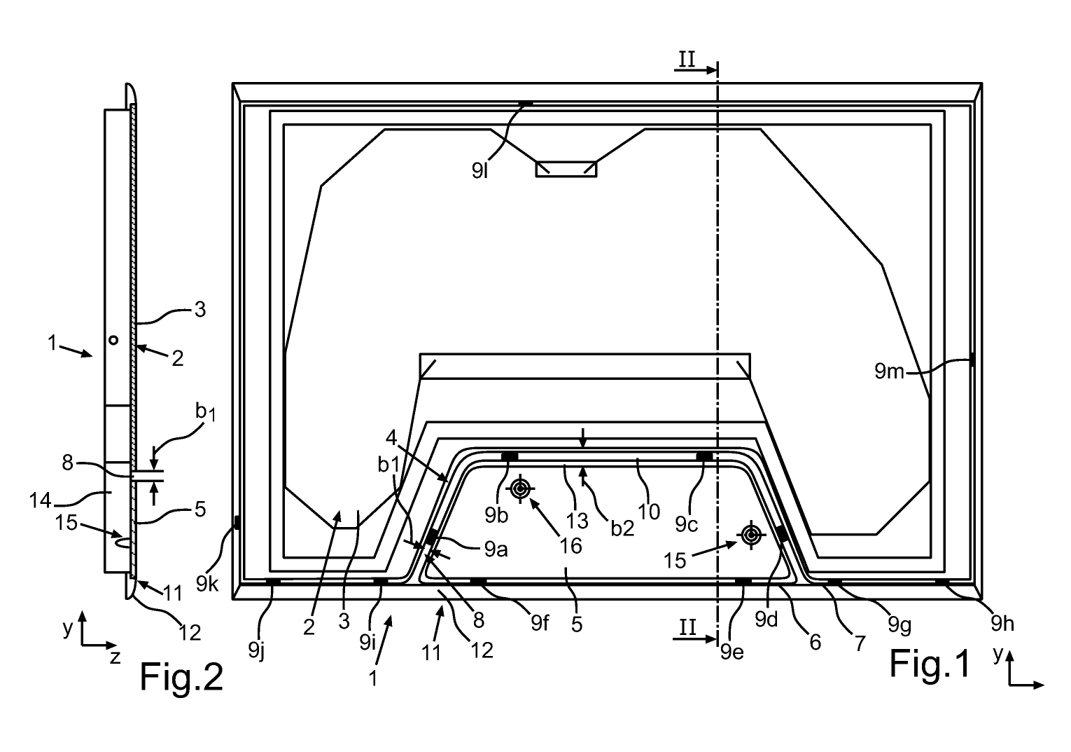

FIG. 1 an overhead view of an inventive hob;

FIG. 2 a sectional diagram of the hob depicted in FIG. 1;

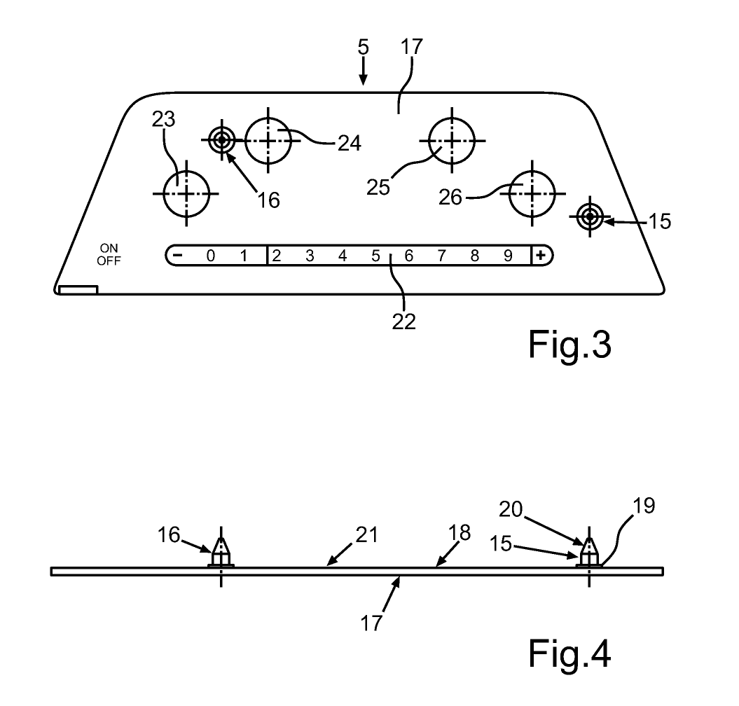

FIG. 3 an enlarged diagram of an overhead view of the insert of the hob depicted in FIG. 1; and

FIG. 4 a side view of the insert as depicted in FIG. 3.

Identical elements or elements with the same functions are provided with the same reference signs in the figures.

FIG. 1 shows an overhead view of a hob 1 which has a cooking surface 2 made of glass ceramic 3. A preparation vessel, for example a pot or a pan or the like, can be positioned or placed on this glass ceramic 3. The cooking surface 2 comprises at least one cooking zone not shown in any greater detail, which has a heating device.

On the front edge 7 of the glass ceramic 3 and thus also of the hob 1 a cutout 4 is made on the edge of the hob in the x-direction centrally in the glass ceramic 3. In the assembled state of the hob 1 shown in FIG. 1 an insert 5 is arranged in this cutout 4 which is embodied from a different material compared to the glass ceramic 3. In particular this difference in the material is designed in respect of the different optical properties of the glass ceramic 3 and the insert 5. The cutout 4 and also the insert 5 are embodied in the exemplary embodiment as trapezoidal in shape, with a front edge 6 of the insert 5 being arranged flush with the front edge 7 of the glass ceramic. The insert 5 thus does not extend beyond the front edge 7 of the glass ceramic, which makes for a space-saving design of the hob 1. The fact that the insert 5 is positioned as far out as possible and thereby in the edge-side cutout 4 means that the dimensions of the rest of the cooking surface are not restricted and the functionality, especially also in respect of dimensioning and arrangement of the cooking zones, is thus not adversely effected by the position of the insert 5.

In the exemplary embodiment the insert 5 is embodied from gray glass and one of its characteristics is permeability to light in the blue spectral range. In addition the insert 5 is also permeable to light in the red and yellow spectral range. This embodiment makes it possible to display the widest range of colors, enabling a very wide diversity of settings, control options and indicators to be specified in color. This differentiation feature thus also enables the user of the hob 1 to be provided with a wide diversity of information that can be perceived more quickly and differentiated more easily. Since the material of the glass ceramic 3 absorbs light in the blue spectral range, the insert 5 enables the functionality of the hob and especially of the display and/or control area of the hob 1 to be significantly improved. The display and/or control area of the hob 1 is specified by the insert 5. To this end one or more light sources, especially light emitting diodes, are arranged below the insert 5. Also arranged below the insert 5 is a circuit board which comprises the control electronics.

The insert 5 is arranged at a distance from the glass ceramic 3 and not in contact with the latter in the cutout 4. A gap 8 embodied between the insert 5 and the glass ceramic 3 has a width b1 which amounts to some 4 mm in the exemplary embodiment.

The insert 5 is joined to the glass ceramic 3 in the cutout 4 by two different adhesives. On one hand there is provision for it to be attached by a UV adhesive only embodied as dots, with there being provision on the other hand for a silicon adhesive 10. This is embodied as a bead and extends over the entire length of the cutout 4 between the glass ceramic 3 and the insert 5. The UV adhesive is only realized by the dots of adhesive 9a, 9b, 9c and 9d.

In addition this UV adhesive is also intended for attachment of a decorative frame 12 around the circumference of the glass ceramic 3 and the insert 5, with the relevant dots of adhesive 9e, 9f, 9g, 9h, 9i, 9j, 9k, 9l and 9m being indicated here. Both the location of these dots of adhesive 9e to 9m and also the number of dots of adhesive on each of the edges of the surround are merely shown by way of example. Preferably several such dots of adhesive are embodied on each side on the edges of the surround.

As well as the decorative frame 12 embodied around the circumference, the gap 8 in the cutout 4 is also covered by a decorative frame 13 when viewed from above and thus when seen in the overhead view depicted in FIG. 1. Preferably the decorative frame 12 and the decorative frame 13 are embodied in one piece and form the overall decorative frame 11.

The decorative frame 13 has a width b2 which amounts to 15 mm in the exemplary embodiment.

As well as the decorative frame 11, the hob 1 also includes an installation frame 14 (FIG. 2) which is linked to the decorative frame 11, especially to the decorative surround frame 12. The glass ceramic 3 and the insert 5 is arranged or clamped in and held in a stable position between the decorative frame 11 and the installation frame 14.

Arranged on the rear side of the insert 5 in the exemplary embodiment are two centering elements 15 and 16 which extend downwards in the form of pins. The centering elements 15 and 16 engage in the assembled state of the hob 1 into recesses in the circuit board of the control electronics arranged thereunder, which produces an exact positioning between the insert 5 and the display unit and/or the light sources. This allows the light emitted by the light sources and the display unit to pass through the insert 5 in a very exact manner at the desired specific position and for a position-specific backlighting to be guaranteed.

FIG. 2 shows a sectional diagram along the cut line II-II of the hob 1 as depicted in FIG. 1. The centering element 15, extending downwards to a point like the centering element 16, is shown. In the diagram depicted in FIG. 2 the decorative frame 13 over the gap 8 is not shown for the sake of clarity. As can be seen in the diagram according to FIG. 2, the insert 5 has the same thickness (extension in the z-direction) as the glass ceramic 3.

FIG. 3 shows a view of the insert 5 from above. A scale 22 and areas 23, 24, 25 and 26 for displaying symbols can be seen on the front side. Both the scale 22 and also the areas 23 through 26 are arranged, especially printed, on a rear side 18 of the insert 5 shown in FIG. 4. The scale 22 and the areas 23 through 26 are printed on in a white color which, when viewed from the other side, because of the embodiment of the insert 5 as gray glass, no longer appears pure white, but in a gray tone. In addition the permeability of the light in the blue spectral range is not adversely affected by the scale 22 and the areas 23 through 26.

FIG. 4 shows the side view of the insert 5 as depicted in the diagram in FIG. 3. On the rear side 18, as well as the printing with the scale 22 and the areas 23 through 26, a black coating 21 is applied to the remainder of the surface which can be realized as a foil or especially as an imprint. This coating 21 does not adversely affect the permeability of the light in the blue spectral range.

The centering element 15 has an adhesion point 19 which makes it possible to attach it to corresponding components of the hob 1. In addition the tip 20 of the centering element 15 engages in the already-mentioned recess in the printed circuit board arranged below the insert 5. The centering element 16 is embodied in a similar manner.

To produce the hob 1 in accordance with the diagram shown in FIG. 1 the decorative frames 12, 13 are first turned over and the upper side thus lies facing downwards on an installation device. The glass ceramic 3 already provided with the cutout 4 is then likewise turned over and, with its upper side shown in FIG. 1 pointing downwards, is inserted into these decorative frames 12, 13. The procedure is the same for the insertion of the insert 5 into the decorative frames 12, 13, so that here too the upper side or front side 17 is arranged pointing downwards. In a subsequent production step dots of UV adhesive are then applied as is shown by way of example by the corresponding dots of adhesive 9a through 9m. In particular a number of dots of adhesive per side are realized on each side of the surround. After the UV adhesive has hardened the silicon adhesive 10 is then applied as a bead in the gap 8. The imprinting of the insert 5 on the rear side 18 with the areas 23 through 26, the scale 22 and the black coating 21 is carried out before the insertion of the insert 5 into the turned-over decorative frames 12, 13. The insert 5 is joined to the decorative frames 12, 13 and to the glass ceramic 3 by the UV adhesive and the silicon adhesive 10.

Subsequently the installation frame 14 is then also assembled. Further or preceding method steps of subordinate importance for the invention and will not be described in any greater detail here since they essentially represent known method steps.

It should additionally be mentioned that the join between the insert 5 and the glass ceramic 3 can also be made in another way. The adhesive joint can thus also be replaced by a another type of joint or if necessary are also be supplemented.

1-9. (canceled)

10. An insert for a hob comprising a material that is permeable to light in a blue spectral range.

11. The insert of claim 10, wherein the material comprises gray glass.

12. The insert of claim 10, wherein the insert comprises a black coating that is permeable to light in a blue spectral range on a rear side.

13. The insert of claim 12, wherein the black coating comprises a film.

14. The insert of claim 13, wherein the black coating comprises an imprint.

15. The insert of claim 10, further comprising a symbol or scale applied to a rear side.

16. The insert of claim 10, further comprising a centering element on a rear side for positioning relative to a display or a light source of a hob.

17. The insert of claim 10, wherein the insert is a trapezoid shape.

18. The insert of claim, wherein the insert is insertable on an edge of a hob.
